(19) United States
(12) Patent Application Publication
(10) Pub. No.: US 2014/0237377 A1
(43) Pub. Date: Aug. 21, 2014

(54) GRAPHICAL USER INTERFACE METHODS TO DETERMINE AND DEPICT RELATIVE POPULARITY OF INTERNET OFFERINGS

(71) Applicant: Oliver Robert Meissner, Washington, DC (US)

(72) Inventor: Oliver Robert Meissner, Washington, DC (US)

(21) Appl. No.: 14/070,739

(22) Filed: Nov. 4, 2013

Related U.S. Application Data
(60) Provisional application No. 61/726,888, filed on Nov. 15, 2012.

(51) Int. Cl. G06F 3/0484; G06F 3/0482

(52) U.S. Cl. CPC G06F 3/04842; G06F 3/0482
USPC 715/745

(57) ABSTRACT

The present invention relates generally w a method to enable computerized device users, Internet service and product providers, media companies and others to be aware of the relative popularity of offerings, such as media, other digital files, products, services, representations of people and other items, available is the Internet, including through mobile applications (offerings), through a simple, easy to view graphical user interface (GUI) which can be viewed on computer platforms such as desktop, tablet and laptop computers, smart phones, head and wrist mounted computers and other devices. Based on number of web-hits to, selections of addition to or subtraction from a favorites database, number of purchases of, duration of viewing, listening to, or otherwise experiencing a certain offering by a user, or combination thereof, the offering's popularity rank is dearly graphically depicted and updated in real time, or regularly, with the capability to view the offering popularity relative to other offerings in a certain database of offerings. The GUI may be interactive with down-select options and possibility to zoom in and out to small or large numbers of offerings represented therein.

### CROSS-REFERENCES TO RELATED APPLICATIONS

This application claims priority from provisional Application No. 61/726,888 entitled “Graphical interface methods for use in providing popularity rankings for products available on the Internet”, filed on Nov. 15, 2012, winch is hereby incorporated herein in its entirety.

### BACKGROUND OF THE INVENTION

The present invention relates generally to a method to enable computerized device users. Internet service and product providers, media companies and others to be aware of the relative popularity of offerings, such as media, other digital files, products, services, representations of people and other items, available via the Internet, including, through mobile applications, (offerings), via a simple, easy to view graphical user interface (GUI) which can be viewed on computer platforms such as desktop, tablet and laptop computers, smart phones, head and wrist mounted computers and other devices.

The use of the Internet has resulted in an abundance of offerings available to computerized device users (users) by providers and hosts of offerings (providers). The sheer volume of offerings makes it difficult and overwhelming for the user and providers, to depict which offerings are more or less popular compared to other offerings, and also makes it difficult to conic to determinations regarding which offerings will be, or are, more or less popular than others and, therefore, may embody a higher chance of being of quality and more likely to appeal to users. Similar determinations can also assist providers to determine which offerings may be easier to market and sell to consumers.

It is often a goal of providers to be able to reach the highest number of users possible by providing offerings that users want to experience. Past popularity is a common way of determining which offerings will be appealing to a user. For example, if an offering has shown to be popular with other users, then there is a better chance that the offering will also be popular with the targeted user. In addition, it is often the case that users will enjoy an offering just because they notice that it is popular with many other users.

It would be beneficial to both users and providers if graphically clear and simple systems or methods were available to both depict and determine relative popularity of offerings relative to other offerings in a database, in order to make it clear what the relative popularity of offerings is within a given database of offerings. Providers must go beyond just lists, numbered depictions of popularity based on thumbs-up/thumbs-down, number of likes, number of views and other methods, in order to make it more evident to providers and users which offerings are more or less popular than others.

Kundtz US Published Patent No. 2007/7,209,895 B2 describes a system for use to notify individuals about potential fraud by allowing Internet users to receive an analysis of other users' prior transaction history. Based on the generated rating delivered to a user, a user can make a determination as to whether or not he can trust the user with whom he is considering doing business with.

Ma US Published Patent No. 2012/8,230,360 B2 describes a system to provide a graphical user interface (GUI) representing content to a user. It provides an interface for a user to provide input regarding the content as well as a display area to display available content items.

Heinberg US Published Patent No. 2003/6,647,355 B2 describes a system to hierarchically and arithmetically assign ranking values to people, for dating/matchmaking reasons.

Ramesh US Published Patent No. 2013/8,463,036 B1 describes a system for shape-based search of a collection of content, and creating refinement shape hierarchies consisting of parent and child refinement shapes. This can be applied, for example, to products offered for sale on the Internet.

Curtis US Published Patent No. 2013/8,434,024 B2 describes a system for automatically and programmatically generating a GUI which assimilates friend recommendations for media offerings. It involves assembly of a media recommendations list, arranged based on relevance, which is provided to the user.

Yach US Published Patent No. 2012/8,245,143 describes a method and handheld device which arranges icons dynamically within a GUI displayed on the user device.

### BRIEF SUMMARY OF THE INVENTION

The present embodiments provide a method for use in enabling providers and users to monitor in real time on a graphical user interface (GUI) the relative popularity of offerings available on computerized devices. By using computer programming or other methods, all the offerings in a certain database are depicted individually by a graphical representation, such as a block or a circle, and the offerings are automatically arranged in order of popularity in a collective graphic. A user favorites database, wherein the user can add offerings to or subtract offerings from, can be included for every user.

In one embodiment, the offerings of a database are automatically arranged in a simple GUI, such as a rectangular grid, pyramid, or concentric circle or other graphic, that clearly depicts which offering is absolutely the most popular, with less popular media tiles arranged in hierarchical fashion around the most popular offering, thereby displaying relative popularity of all offerings in the database. Users can zoom in or out, or move around the GUI, and visually see smaller and larger versions of the database in order to overcome limitations of all items in the database fitting onto one screen. For example, for a pyramid GUI, the top product could be represented by a block graphic at the top of a pyramid graphic, and less popular offerings will be arranged with the offering of the absolute highest popularity at the top of the pyramid graphic, and successively less popular offerings arranged from left to right in successively lower rows, with the offerings in successively lower rows arranged successively from left to right in order of relative popularity, with offerings further to the left representing offerings of higher popularity than those offerings to the right The GUI is updated automatically through Internet network communication with the database being represented by the GUI.

This GUI enables both Internet providers and users to be aware of the relative popularity of the offerings available in a certain database, and make decisions, such as business decisions, personal decisions and other decisions, regarding the offerings. For example a user may decide to listen to a song in a database represented in the GUI of the current invention, simply because it is the most popular song in the database. As another example, a provider may decide to market only songs in the top 10 rows of the pyramid graphic of the pyramid based GUI, by way of reasoning that those songs will be most popular based on performance in the current database.

### BRIEF DESCRIPTION OF THE DRAWINGS

The above features and advantages of the invention as well as additional features and advantages thereof will be more clearly understood hereinafter as a result of a detailed description of embodiments of the invention when taken in conjunction with the drawings. Like reference numerals refer to corresponding parts throughout the several views of the drawings.

FIG. 1 illustrates an Internet offering ranking environment flow chart in accordance with an embodiment of the present invention.

FIG. 2 illustrates a rectangular grid GUI to display ranking of offerings for present invention.

FIG. 3 illustrates a pyramid GUI to display offering ranking of offerings for the present invention.

FIG. 4 illustrates a circular GUI to display offering ranking of offerings for the present invention.

FIG. 5 illustrates a wearable eyeglass environment of the present invention wherein a user can select specific offerings in a GUI through eye movement or eve behavior.

FIG. 6 illustrates a computing database and user delivery environment for the present invention.

### DETAILED DESCRIPTION OF THE INVENTION

The present embodiments provide methods for use in determining and depicting, through a graphical user interface (GUI), which media files, representations of products, services, people or other offerings, collectively called offerings, available via the Internet on computerized platforms are more, or less, popular than others. This allows users to choose which offerings to select based on its popularity ranking. Users can select one of the more popular offerings, or they can select less popular offerings and perhaps discover as hidden gem. It also allows users and Internet offering providers to view in real time how a particular interact offering increases or decreases in popularity. This invention also can be used by businesses, and even in politics, as test cases in order to determine which offerings will have a higher chance of being popular, and thereby determine which Internet offerings deserve more marketing funding, support, votes, merit investment.

Many providers offer media, such as music or video, files for playing or otherwise experiencing, and sometimes for sale through download, online purchase and other means. Currently, to determine, depict and predict popularity, providers and users rely primarily on user ratings, based on, for example, a star or similar rating system, where a user inputs, for example, five stars for a highest rating and one star for lowest rating, or a Thumbs-Up/Thumbs-Down rating system, often represented by a picture of an upward pointing thumb for a positive rating or vice-versa, or number of times an offering is clicked on, played, or selected, or the number of times a user has clicked on a “like” or similar icon representing that they liked a particular offering, or other means, to determine the present and predicted popularity of an offering. Popularity is often depicted to users through lists or quantitative means, such as listing the number of plays of a particular offering, and/or the number of Likes or Thumbs-Up for a particular offering. In addition, offering providers monitor which products are purchased by a user and will then suggest future similar products, for example products with similar genre, themes, etc., to this user.

To better understand the various embodiments of this invention, a discussion relating directly to the drawings follows.

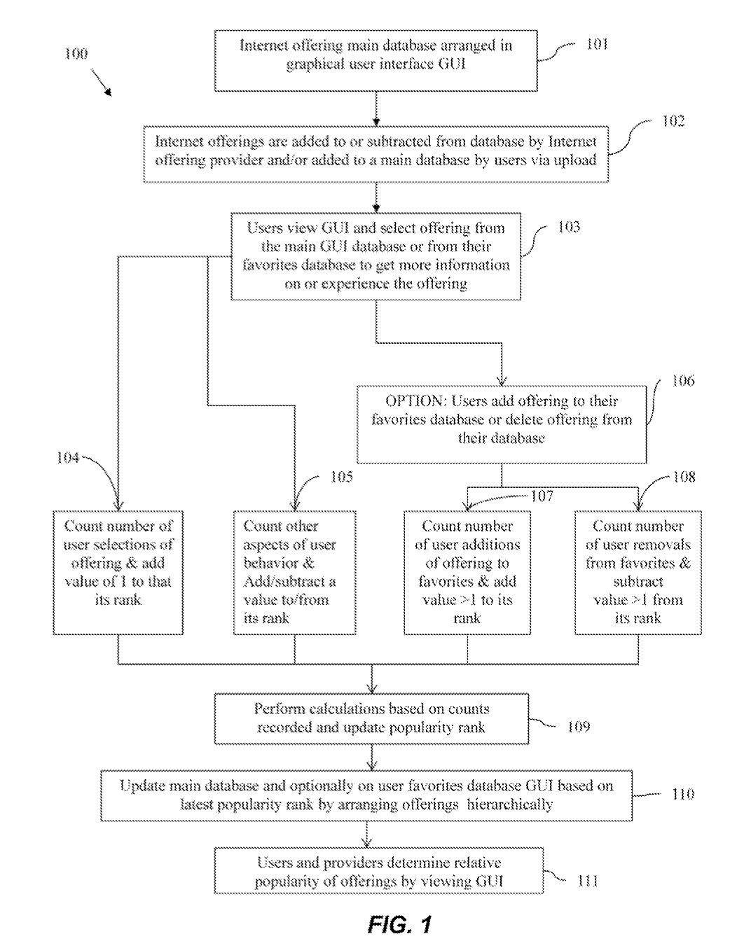

FIG. 1 depicts a processing methodology flowchart 100 for use in the present invention, A provider will begin with a main database of offerings, such as media, other digital files, products, services, representations of people and other items. The database can initially consist of zero or greater than zero items in a main database, depending on whether or not the provider has offerings available when the GUI is first launched. For the case that the provider starts with zero offerings, then the provider can graphically represent empty database items with a block, circle or other graphic. For the case that the provider has offerings available when he initially launches the GUI, the provider may choose to initially randomly distribute the offerings throughout the graphical user interface GUI 101. Users can consist of both people who want to experience or find out more information about the offerings and/or be people who would like to contribute offerings to the main GUI database. Users can view the GUI either by going to the website or application, or depending on provider preference, can register with the provider as a user in order to be able to view and upload to the GUI. For the case that users register to view the GUI, then a favorites database can be set up automatically through computer programming methods, and this favorites database can be displayed on its own GUI, in addition to the main database. The provider and, if the provider decides to allow it, users, can add offerings periodically by uploading offerings, such as media tiles or other information, to the main database 102.

Users who would like to experience or find more information about the offerings view the main database GUI, and optionally view their favorites database GUI on their computing device and then select an offering to be able to experience it or find out more information about it 103. Once users begin to click on or otherwise select a specific offering within the GUI, in order to find more information about, listen to, view or otherwise experience the offering, an accounting is made, automatically through computer code or otherwise, to determine the number of times the offerings have been experienced 104 and/or accountings are made regarding other aspects of user behavior, such as for example, determining the length of time the offering is experienced by the user 105. The latter accounting may be determined in the case of, for example, streaming of media files, where a constant connection to the Internet is required and the user's time experiencing the file can be monitored by the content provider.

Users can be given the option by the provider to be able to add offerings to or subtract offerings from a user favorites database by way of a button click or other selection method indicating this desire 106. For this case the popularity ranking method can take into account the number of times an offering is added to or subtracted from a user's favorites database. As an example, a value greater than one could be added to the popularity ranking every time a user adds a specific offering to the user's favorites database 107, and a value greater than one (1) could be subtracted every time a user subtracts a specific offering from the user's favorites database 108.

Calculations 109 are then made using data from one or more of the aforementioned accounting methods 104, 105, 107, 108. Based on the calculations, the popularity rankings of all the offerings in the main GUI database, and optionally in the user's favorites database, are updated. As an example, offerings with higher values resulting from the calculations can be considered more popular than offerings with lower values. Based on the updated offering popularity ranking, the main database GUI, and optionally also the user favorites database GUI, can be updated automatically or otherwise, to reflect the most recent popularity ranking hierarchically 110. At this time providers and users will be able to clearly determine which offerings are more popular than others 111.

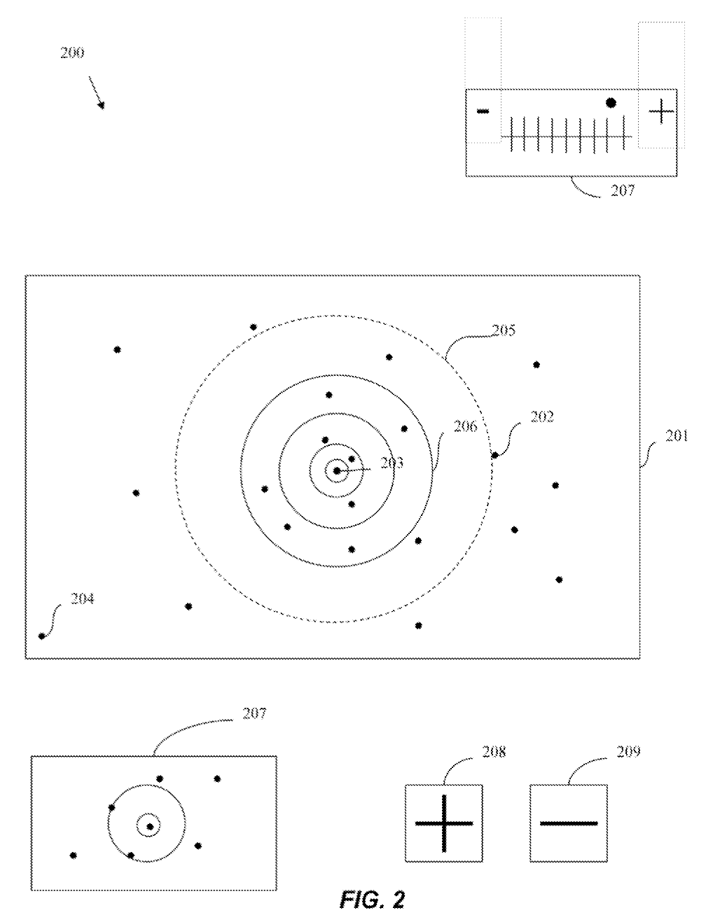

A first type of GUI possible with the present invention is a grid type GUI FIG. 2 The grid 201 can be automatically sized identically or similarly, to the screen of the computing device of the user, or may be sized otherwise in rectangular fashion. Offerings can be depicted by a dot, circle, block or other graphic 202, and they are arranged in hierarchical fashion with the most popular offering 203 located at the center-most point of the grid, and the least popular offering located at the furthest point from the center-most point of the grid 204. To distribute the offerings, the offerings 202 can be distributed randomly around the circumference of a circle 205 with radius equal to its prorated popularity value. This grid GUI can also contain rings 296 to create a bulls-eye effect and help the users see which offerings are more popular than others, and the most popular offering can be located alone within the inner most ring. The grid GUI can be zoomed in or out by the user or content provider clicking and/or sliding a zoom bar or other interactive graphic 207 or by other methods. For example if a user wants to see the five most popular offerings only, the user will move the slider closer to the “+” sign, or other sign indicating zooming in, and—if the user wants to see, for example, how 100 offerings compare in popularity the user will move the slider closer to the “−” sign, or other sign indicating zooming out. The user may also be given the option to add offerings that they like to a favorites grid GUI 207 which can be depicted as a smaller version of the main GUI 201. The favorites GUI 207 represents the users favorite offerings and will normally consist of fewer offerings within it than for the main GUI. The user can add offerings to the favorites GUI by selecting an icon such as a plus sign icon 208, or other icon, or otherwise depicting this desire, and the user can remove offerings from the favorites GUI by selecting an icon such as a minus sign icon 209, or other icon, or otherwise depicting this desire. The grid GUI and other GUI types can be depicted either in two dimensional or three dimensional or other fashion.

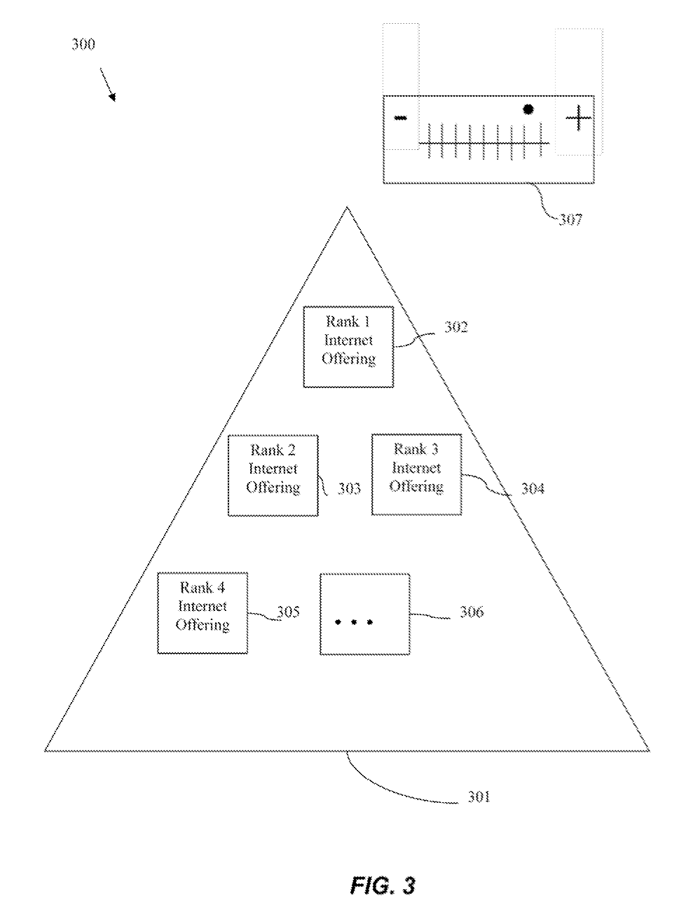

A pyramid type GUI is depicted in FIG. 3. The pyramid 301 has offerings depicted within it 302-306 ordered by popularity ranking. The most popular offering 302 is at the top of the pyramid 301, with less popular offerings 303-306 descending below. This makes it clear which offering is absolutely the most popular with less popular offerings arranged in lower hierarchical fashion around the top offering. For example, in a pyramid the top offering will be at the top of the pyramid and less popular offerings will be in successively lower rows. This will enable both users and providers to monitor the popularity of offerings relative to one another. As time proceeds, the offerings will be re-ranked accordingly to depict the present popularity ranking. The pyramid GUI can be zoomed in or out by the user or content provider by clicking, and/or sliding a zoom bar 307, similarly to the depiction 207 for the grid GUI. The pyramid GUI can also have the user favorites GUI customized for the pyramid GUI, similar to 208-210.

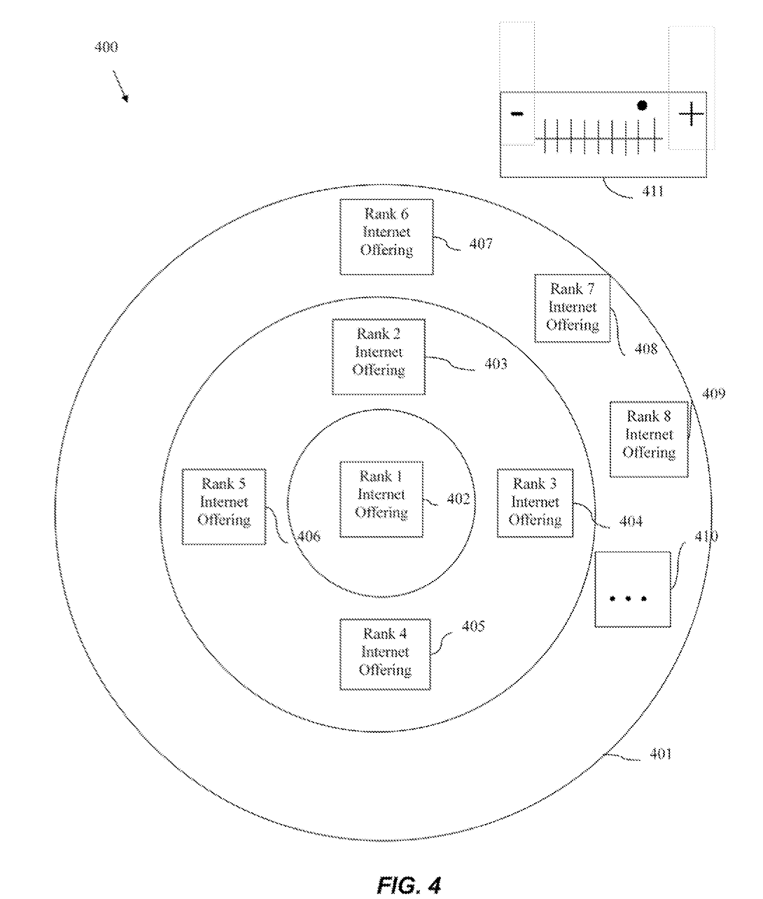

The present invention allows for a multitude of other GUIs, including concentric circle, zig-zag, or curving tail or other graphical depictions. FIG. 4 depicts a variation on the first grid GUI FIG. 3 and pyramid GUI FIG. 2. FIG. 4 depicts a concentric circle graphic interface 401 where the most popular offering 402 is in the center of the GUI, and successively less popular Internet offerings are arranged in the larger concentric circles 403-410. All conceivable GUI's can also employ user favorites GUI's similar to 208-210.

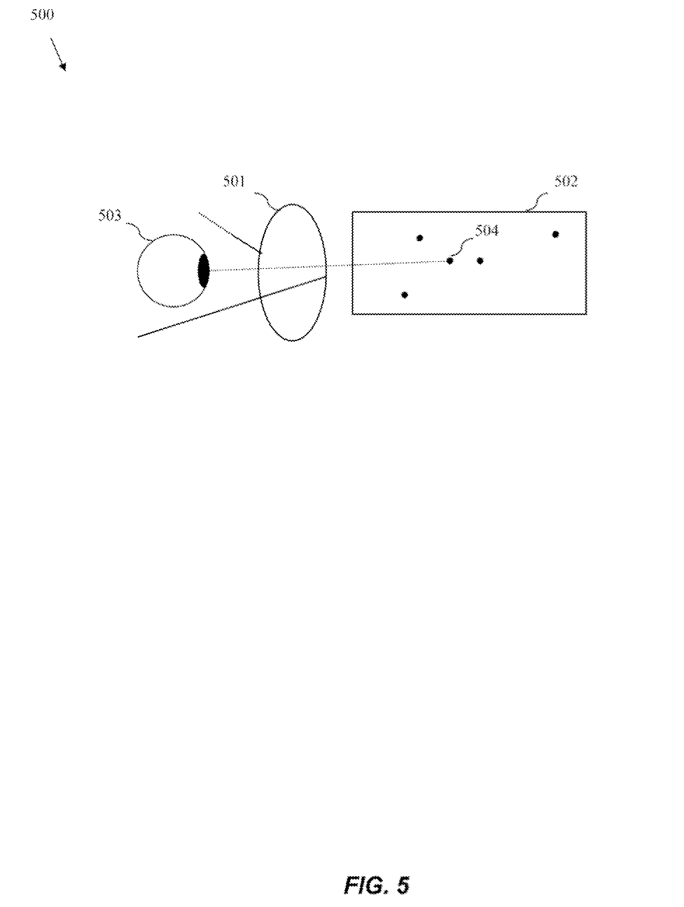

FIG. 5 depicts an environment wherein the offerings are on a visual based computerized platform, such as Google Glass 501, on which the user can see the GUI 502 as an image in front of the user's eyes 503 as a projection, hologram or displayed via other optical technique. In addition to using a mouse, tooltip, hover or other type of offering selection method, the user can look at a specific offering 504 on the GUI and use an eye-based selection method, such as blinking, staring, and thereby automatically selecting the offering, or displaying an informational and/or actionable tooltip or popup regarding the offering.

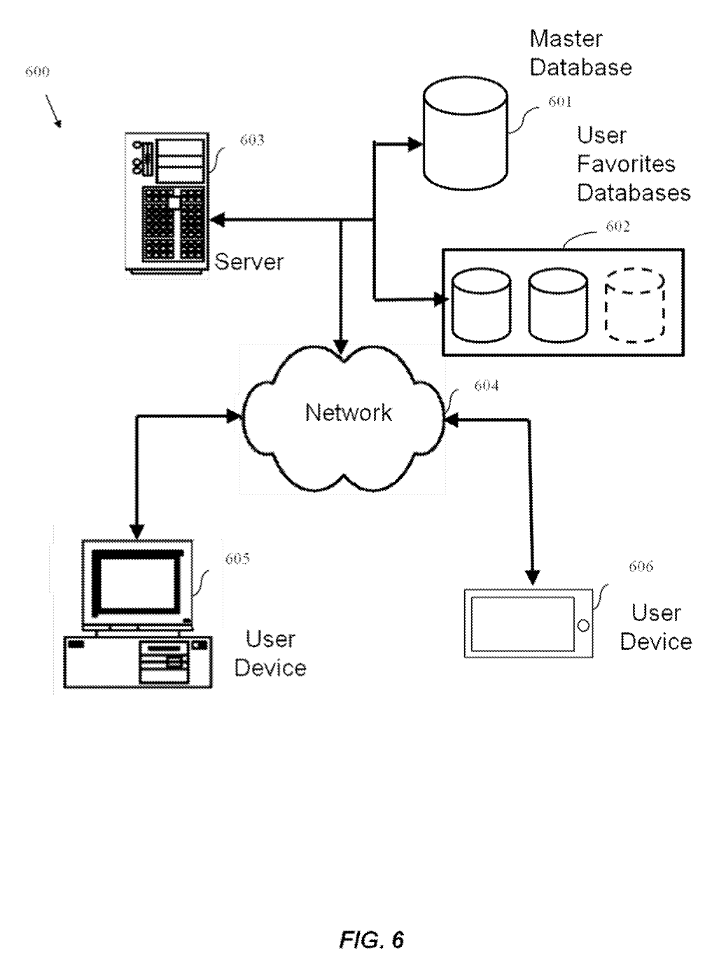

FIG. 6 depicts an example computing environment for the current invention. All offerings of a main database 601 of a provider, and optionally all offerings of each registered user's favorites databases 602 are stored on a server 603 operated by the provider. The databases are regularly updated and referenced programmatically either locally, or over a network 604, through computer programming code such as PHP language or other database programming languages. The main GUI depicting all the offerings, and optionally the GUI depicting the user's favorites database, are accessed by the user over the network via internet signal on user devices such as a desktop computer 605, mobile device 606, or on other computerized devices. Users may also have the option to natively store the databases on their device for the case of a mobile application which is not connected to the internet.

In one embodiment, all offerings in a database are given a starting ranking of zero (0) and displayed randomly in the GUI. Through tooltips, popups, or other display features, users can be informed as to the title or other identifying factor for an offering when scrolling over the depiction, such as a block icon, of the offering with a computer cursor, tapping the offering depiction, or otherwise demonstrating an interest in receiving more information about an offering. Then a user can click, or otherwise select, the offering to experience the offering. For the case of a music or video file, the offering would be automatically played when it is selected for playing. The selection of the offering may or may not also involve a purchase of the offering. Each time a user selects an offering from the GUI, a value of one (1) is added to that offering's popularity rank. For example, the first time an offering is selected by a user, its ranking increases from zero to one, the second time from one to two, and so on. The most popular offering on a GUI, based on a higher popularity ranking value compared to any other offerings on the GUI, is located on the point depicting the top hierarchical ranking. For example for a grid GUI the most popular offering is in the absolute middle of a rectangular shaped grid, for a pyramid GUI the most popular offering is located on the top, or apex, of the pyramid, and for a circle GUI, the most popular offerings is located in the middle of the circle. Less popular offerings are distributed in hierarchical fashion below or around the most popular offering. This will enable both users and providers to monitor the popularity of offerings relative to one another. In order to prevent artificially inflating an offering's popularity, limits can be placed on the number of times a user can listen to, view, or otherwise experience a song, and affect the popularity ranking. This can be effected by monitoring user's Internet protocol (IP) addresses, or through other methods, and placing an upper limit, such as ten (10) times per day, on the number of times a user can listen to, view or otherwise experience an offering and affect the offering's popularity ranking through addition of points.

In one embodiment, offerings are given a popularity ranking, based, for example, on the number of times an offering is experienced b a user, through purchase or otherwise, combined with the experience time as a percentage of the total experience time possible with said offering. For example, each time an offering is listened to, viewed or otherwise experienced, one (1) point is added to the offering's popularity ranking. The offering with the highest number of points is then depicted as the most popular offering in the database. As an example, an offering with 100 selections is ranked higher than one with 50 selections.

In one embodiment, the present invention allows for user or provider sub-selection by genre or other more specific groupings. For example movie media files may have an overall GUI and a user can also view a graphical user interface for comedy movies or action movies. This allows another level of specificity for determining offering popularity.

In one embodiment, for the case of smaller amounts of offerings viewed on the GUI, a representative picture and/or information about the offerings may be displayed in each offering depiction of the GUI. If a large amount of offerings are viewed they may only be depicted by small squares, dots or similar graphics—as the user scrolls over the offering depictions with a computer cursor, or other method, a representative picture and/or information about the offering will be displayed.

In one embodiment, as time lapses, the GUI can be updated on a predetermined time interval, i.e. every hour on the hour, it can be updated continuously, it can be updated by the user or provider clicking on a refresh button on the website, or some combination of these, or other, updating techniques.

In one embodiment, offerings can be added and subtracted by the provider as necessary. For example, more offerings may be made available to the content provider for Internet distribution or offerings may need to be removed for contractual or other reasons. At any time, users are able to request and transact for offerings based on popularity and content providers are able to make marketing and distribution decisions based on popularity by viewing the GUI.

In one embodiment, the popularity ranking method takes into account the number of times an Internet offering is added to or subtracted from a user's favorites database. As an example ten (10) points could be added to the popularity ranking every time a user adds a specific offering to the user's favorites database, and five (5) points could be subtracted every time a user subtracts a specific offering from the user's favorites database. The favorites database can be depicted as a smaller version of the main database GUI. For example, for the case of a pyramid shaped GUI, the favorites database GUI could be a smaller sized pyramid than the main database pyramid, and have a smaller number of offerings in it than the main database GUI.

In one embodiment the offerings are on a visual based computerized platform, such as Google Glass, on which the user can see the GUI as an image in front of the user's eyes as a projection, hologram or displayed via other optical technique. In addition to using a mouse, tooltip, hover or other type of offering selection method, the user can look at a specific offering on the GUI and use an eye-based selection method, such as blinking, staring, and thereby automatically selecting the offering or displaying an informational and/or actionable tooltip or popup regarding the offering.

In one embodiment of the present invention, the GUI can optionally be automatically updated in real time, through, for example, a refresh button which the user can click, continually as transactions for offerings are made and said offerings increase or decrease in popularity, or in automatic time interval updates. For example, at 3:00 pm on a given day, media file A can be at the highest hierarchical position on the GUI with popularity rank of 1, and media file B at a lower down hierarchical position on the GUI with popularity rank of 25. Between 3:00 pm and 4:00 pm media file B could have been selected many times by users, and also added to some users favorites database, allowing it to overtake media file A in popularity rank. Media file B would then be depicted at the top hierarchical position of the GUI, with a new popularity rank of 1, and Media file A would be depicted lower down hierarchically on the GUI after the GUI update is made, based on the popularity change over time.

In one embodiment, the techniques of the present invention ma be used as a method for providers and their users to easily make determinations regarding relative popularity of offerings, including but not limited to media files and people, by viewing the GUI. Through the current invention, users and content providers, through viewing of the GUI are able to easily determine which media files, for example movie or music files, are more popular than others and which may have a higher chance of being of quality. Providers who also are interested in marketing and distribution of media through a multitude of distribution channels, may similarly use the GUI to determine which media files have the highest popularity and then make decisions as to which media files are worthwhile to market for sale through a multitude of distribution channels. Users can utilize a smaller version of the GUI as a favorites database GUI, in order to be able to have quick access to those offerings.

The invention has now been described in detail for purposes of clarity and understanding. However, it will be appreciated that certain changes and modifications may be practiced within the scope of the appended claims. Accordingly, it should be recognized that many other systems, functions, methods, and combinations thereof are possible in accordance with the present invention. Thus, although the invention is described with reference to specific embodiments and figures thereof, the embodiments and figures are merely illustrative, and not limiting of the invention. Rather, the scope of the invention is to be determined solely by the appended claims.

What is claimed is:

1. A method featuring a graphical user interface (GUI) for use in displaying and determining relative popularity of offerings, such as media files, other digital files, descriptions of people and things, and other offerings available on computerized, devices, said offerings being individually represented by a dot, circle, square or other graphic, in a database of an offering provider, through a continually updating graphical mechanism displayed over the Internet on a desktop computer, mobile phone or other electronic platform, or locally on a user device application not necessarily requiring an Internet connection, wherein based on number of selections of offerings by a user and/or addition to or deletion from a favorites database by a user, the offering is assigned an updated popularity rank and the GUI is updated regularly, with the capability to view offering popularity relative to other offerings within a certain database of offerings.

2. The method of claim 1, wherein the GUI appears on a website page, mobile phone website, application, app, or a visual based computerized device such as Google Glass.

3-7. (canceled)

8. The method of claim 1, wherein selections of offerings are made by users clicking on, tapping on, hovering over, looking at, blinking at or otherwise signaling a selection of an offering on the GUI and wherein selecting an offering on the GUI results in information being displayed describing the offering and/or users being able to listen to, view or otherwise experience the offering.

9-11. (canceled)

12. The method of claim 1, wherein the popularity rank is updated based on the number of selections of, purchases of, duration of viewing or listening to or otherwise selecting, or experiencing the offering and wherein the most popular of offering has the highest number as popularity rank and the least popular offering has the lowest number as popularity rank.

13-17. (canceled)

18. The method of claim 1, wherein each time a user selects an offering, then one (1) point is added to the offering's popularity ranking.

19. The method of claim 1, wherein users are limited through computer programming or other method to a certain maximum number of selections of an offering per day by detecting the users' interne protocol (IP) address and tracking the users' number of user selections, including by clicks and other means, per day, or through other methods.

20. The method of claim 1, wherein a user can click an icon such as a plus sign, or otherwise select an offering to add the offering to the user's favorites database, and wherein a user can click an icon such as a minus sign or otherwise select an offering to remove the offering from the user's favorites database.

21. (canceled)

22. The method of claim 20, wherein a point ranking greater than one (1) point is added to the offering's popularity ranking every time a user moves an offering to the user's favorites database and wherein a point ranking greater than one (1) point is subtracted from the offering's popularity ranking every time a user removes an offering from the user's favorites database.

23. (canceled)

24. The method of claim 1, wherein the GUI can be regularly or continuously updated to show relative popularity of the offerings through an automatic update, or through a user selection of a page refresh button, other website button or other graphic.

25-26. (canceled)

27. The method of claim 1, wherein a user selects certain offerings from a provider, content provider or other entity's database of offerings, whereby user is able to put those offerings into the GUI on the user's social network, other third party website or app, which then sends relative popularity data to a central database in order for the offering provider or other entity to monitor relative popularity on the central database by viewing the GUI.

28. The method of claim 1, wherein an overarching GUI representing all of the offerings in a database can be narrowed down to a smaller GUI depicting all offerings of a certain genre, type, class or other subset, in combination or individually.

29. The method of claim 1, wherein an overarching GUI representing all of the offerings in a database is accompanied by a smaller GUI depicting all of a user's favorite offerings of a certain category.

30-32. (canceled)

33. The method of claim 1, wherein the GUI can be resized by a user through a slider, button or other control on a website page or represent to represent greater or fewer number of offerings, wherein said resize capability also may include the ability to move to or highlight various regions of the GUI.

34. The method of claim 1, wherein the GUI is automatically resized depending on the current number of offerings in a database.

35-36. (canceled)

37. The method of claim 1, wherein the offering consists of different colors to allow certain offerings to stand-out from those of other colors.

38. The method of claim 1, wherein the GUI is a rectangular or other shaped grid whereupon dots or other graphical elements, each representing an offering, are arranged at as distance closer or further away from the center of the grid depending on the offerings' popularity rank, and wherein the offerings closer to the center of the grid represent more popular offerings and the offerings located further away represent less popular offerings, so that the most popular offering is at the center of the grid and the least popular offering is at the furthest point from the center of the grid, and wherein the offerings are arranged randomly around the circumference of an imaginary circle, said circle with radius equal to the offering's popularity distance from the center of the grid and with its center at the center of the grid.

39-40. (canceled)

41. The method of claim 1, wherein the GUI is an upright 2 or 3-dimensional pyramid whereupon dots or other graphical elements, each representing an offering, are arranged such that offerings higher up on the pyramid represent more popular offerings.

42. The method of claim 1, wherein the GUI is a 2 or 3-dimensional circular graphic consisting of concentric rings, whereupon dots or other graphical elements, each representing an offering, are arranged so that offering representations closer to the center of the circle represent more popular offerings.

43. The method of claim 1, wherein the GUI is a 2 or 3-dimensional circular graphic consisting of a spiral shape, whereupon dots or other graphical elements, each representing an offering, are arranged so that offering representations closer to the center of the spiral represent more popular offerings.

44. The method of claim 1, wherein users have the option to upload offerings to the GUI.
